(19) United States
(12) Patent Application Publication
(10) Pub. No.: US 2026/0299142 A1
(43) Pub. Date: Oct. 1, 2026

(54) RADIATION DETECTOR AND POSITRON EMISSION TOMOGRAPHY APPARATUS

(71) Applicant: HAMAMATSU PHOTONICS K.K., Hamamatsu-shi (JP)

(72) Inventors: Kento HAKAMATA, Hamamatsu-shi (JP); Hidemoto YAMAUCHI, Hamamatsu-shi (JP)

(73) Assignee: HAMAMATSU PHOTONICS K.K., Hamamatsu-shi (JP)

(21) Appl. No.: 19/630,675

(22) Filed: Mar. 27, 2026

(30) Foreign Application Priority Data
Mar. 31, 2025 (JP) 2025-058703

(51) Int. Cl. G01T 1/164; G01T 1/20; G01T 7/00

(52) U.S. Cl. CPC G01T 1/1644; G01T 1/2002; G01T 7/005

(57) ABSTRACT

A radiation detector has a scintillator array including a plurality of first scintillator blocks arranged in parallel with each other in a first layer; one second scintillator block arranged in a second layer so as to extend across each of the plurality of first scintillator blocks; a reflective member disposed between adjacent ones of the first scintillator blocks; a first optical discontinuity portion provided between each of the plurality of first scintillator blocks and the second scintillator block; and a light detection unit optically coupled to an end surface of one of the first scintillator blocks and an end surface of another of the first scintillator blocks.

### INCORPORATION BY REFERENCE

This application is based upon and claims the benefit of priority from Japanese patent application No. 2025-58703, filed on Mar. 31, 2025, the disclosure of which is incorporated herein in its entirety by reference.

### BACKGROUND

The present disclosure relates to a radiation detector and a positron emission tomography apparatus.

A radiation detector including a scintillator (U-shaped scintillator) that has two scintillator portions arranged in parallel with each other and is configured such that light (scintillation light) can propagate between one end portions of the two scintillator portions is known (see, for example, Patent Document 1). The scintillator portions of Patent Document 1 are partitioned into a plurality of segments by modified regions formed by laser irradiation (light scattering portions whose light transmittance varies depending on an incident angle). By forming the modified regions, since a ratio of scintillation light that reaches both end portions of the scintillator varies for each segment in which scintillation light is generated, a segment in which scintillation light is generated can be identified by performing predetermined calculation based on outputs of light receiving elements optically coupled to the both end portions.
[Patent Literature 1] Japanese Patent No. 6726969

### SUMMARY

However, since a positron emission tomography apparatus (PET (Positron Emission Tomography) apparatus) to which a radiation detector is applied generally uses an extremely large number of scintillators, there is a problem in that an enormous amount of man-hours and time are required to form modified regions by laser irradiation in each of the scintillators. For example, when scintillators (for example, 7,000 scintillators) used in a small-sized system are laser-processed one by one by a single operator, it takes 140 days at a rate of 50 scintillators per day. This number of days greatly varies depending on a processing environment.

The present disclosure has been made in order to solve such a problem, and an object thereof is to provide a radiation detector and a positron emission tomography apparatus in which a modified region formed by laser irradiation can be omitted (partially omitted or entirely omitted).

A radiation detector according to a first aspect of the embodiment includes: a scintillator array including a plurality of first scintillator blocks arranged in parallel with each other in a first layer; one second scintillator block arranged in a second layer so as to extend across each of the plurality of first scintillator blocks; a reflective member disposed between adjacent ones of the first scintillator blocks; a first optical discontinuity portion provided between each of the plurality of first scintillator blocks and the second scintillator block; and a light detection unit optically coupled to an end surface of one of the first scintillator blocks and an end surface of another of the first scintillator blocks.

Alternatively, a positron emission tomography apparatus according to a second aspect of the embodiment includes: a subject holding unit configured to hold a subject to which a radioactive agent has been administered; radiation detectors arranged in a ring shape for detecting radiation emitted from the subject; and means for, based on outputs of the radiation detectors, identifying a position at which scintillation light is generated, recording the identified position, identifying a position of a radiation emission site from the recorded positions using a mathematical method, and displaying the identified position on a display device, wherein the radiation detector comprises: a scintillator array including a plurality of first scintillator blocks arranged in parallel with each other in a first layer; one second scintillator block arranged in a second layer so as to extend across each of the plurality of first scintillator blocks; a reflective member disposed between adjacent ones of the first scintillator blocks; a first optical discontinuity portion provided between each of the plurality of first scintillator blocks and the second scintillator block; and a light detection unit optically coupled to an end surface of one of the first scintillator blocks and to an end surface of the other of the first scintillator blocks.

As described above, according to the first aspect or the second aspect described above, since the scintillator configured by the first scintillator blocks and the second scintillator block, which are separate from each other, and the first optical discontinuity portion provided between them is used, a modified region formed by laser irradiation can be omitted (partially omitted or entirely omitted). As a result, compared with Patent Document 1 in which a modification region formed by laser irradiation is provided in each scintillator, it becomes possible to reduce manufacturing cost of the scintillator and manufacturing time of the scintillator.

Further, according to the above first aspect or the above second aspect, since one second scintillator block only needs to be prepared for a plurality of first scintillator blocks in a first layer, the number of scintillator blocks can be reduced. Further, according to the present embodiment, the number of polished surfaces of the scintillator blocks can also be reduced. As a result, it becomes possible to reduce costs by simplifying assembly of the scintillator blocks.

Further, according to the above first aspect or the above second aspect, there is also an advantage that calibration in a DOI direction (for determining a gamma-ray interaction position), which has conventionally been performed in a scintillator in which a modification region formed by laser irradiation is not formed, is unnecessary.

Further, in the above first aspect or the above second aspect, it is also preferable that each of the plurality of first scintillator blocks is partitioned into a plurality of segments by at least one second optical discontinuity. In this manner, it is possible to discriminate a scintillation light generation position in a plurality of layers of three or more layers.

Further, in the above first aspect or the above second aspect, a plurality of first scintillator blocks may be arranged in a matrix in a first layer. In this case, since one second scintillator block only needs to be prepared for the plurality of first scintillator blocks in the first layer, the number of scintillator blocks can be reduced. Further, the number of polished surfaces of the scintillator blocks can also be reduced. As a result, it becomes possible to reduce costs by simplifying assembly of the scintillators.

Further, in the above first aspect or the above second aspect, it is also preferable that the first optical discontinuity portion is an optical adhesive layer or an air layer. This is an example of the first optical discontinuity portion. The first optical discontinuity portion may be other than an optical adhesive layer or an air layer.

Further, in the above first aspect or the above second aspect, it is also preferable that the second optical discontinuity portion is a modified layer formed by laser irradiation applied to the first scintillator block, an optical adhesive layer, or an air layer. This is an example of the second optical discontinuity portion. The second optical discontinuity portion may be other than a modified layer, an air layer, or an optical adhesive layer.

Further, in the above first aspect or the above second aspect, it is also preferable that the light detection unit includes at least one first light receiving element optically coupled to an end surface of one of the first scintillator blocks, and at least one second light receiving element optically coupled to an end surface of the other first scintillator block. That is, one or more first light receiving element s may be optically coupled to the end surface of one of the first scintillator blocks. Similarly, one or more second light receiving elements may be optically coupled to the end surface of the other first scintillator block.

The radiation detector of the embodiment is a radiation detector comprising: [1] a scintillator array including a plurality of first scintillator blocks arranged in parallel with each other in a first layer; one second scintillator block arranged in a second layer so as to extend across each of the plurality of first scintillator blocks; a reflective member disposed between adjacent ones of the first scintillator blocks; a first optical discontinuity portion provided between each of the plurality of first scintillator blocks and the second scintillator block; and a light detection unit optically coupled to an end surface of one of the first scintillator blocks and an end surface of another of the first scintillator blocks.

The radiation detector of the embodiment may be the radiation detector according to [1], wherein each of the plurality of first scintillator blocks is partitioned into a plurality of segments by at least one second optical discontinuity.

The radiation detector of the embodiment may be the radiation detector according to [1], wherein the plurality of first scintillator blocks is arranged in a matrix in the first layer.

The radiation detector of the embodiment may be the radiation detector according to [1], wherein the first optical discontinuity portion is an optical adhesive layer or an air layer.

The radiation detector of the embodiment may be the radiation detector according to [2], wherein the second optical discontinuity portion is a modified layer formed by laser irradiation on the first scintillator block, an air layer, or an optical adhesive layer.

The radiation detector of the embodiment may be the radiation detector according to any one of [1] to [5], wherein the light detection unit includes at least one first light receiving element optically coupled to an end surface of one of the first scintillator blocks, and at least one second light receiving element optically coupled to an end surface of the other of the first scintillator blocks.

The positron emission tomography apparatus of the embodiment may be a positron emission tomography apparatus comprising: a subject holding unit configured to hold a subject to which a radioactive agent has been administered; radiation detectors arranged in a ring shape for detecting radiation emitted from the subject; and means for, based on outputs of the radiation detectors, identifying a position at which scintillation light is generated, recording the identified position, identifying a position of a radiation emission site from the recorded positions using a mathematical method, and displaying the identified position on a display device, wherein the radiation detector comprises: a scintillator array including a plurality of first scintillator blocks arranged in parallel with each other in a first layer; one second scintillator block arranged in a second layer so as to extend across each of the plurality of first scintillator blocks; a reflective member disposed between adjacent ones of the first scintillator blocks; a first optical discontinuity portion provided between each of the plurality of first scintillator blocks and the second scintillator block; and a light detection unit optically coupled to an end surface of one of the first scintillator blocks and to an end surface of the other of the first scintillator blocks.

According to the present disclosure, it is possible to provide a radiation detector and a positron emission tomography apparatus in which a modified region formed by laser irradiation can be omitted (partially omitted or entirely omitted).

The above and other objects, features and advantages of the present disclosure will become more fully understood from the detailed description given hereinbelow and the accompanying drawings.

### BRIEF DESCRIPTION OF DRAWINGS

FIG. 1 is a schematic configuration diagram of the radiation detector 1 according to Embodiment 1;

FIG. 2 is a perspective view of a scintillator 10 and a light detection unit 20 (partially) extracted from FIG. 1;

FIG. 3 is a histogram summarizing calculation results of the DOI information;

FIG. 4 is an example of a positron emission tomography apparatus 60 to which the radiation detector 1 of the present disclosure is applied;

FIG. 5 is an example of a positron emission tomography apparatus 60 to which the radiation detector 1 of the present disclosure is applied;

FIG. 6 is a perspective view of a scintillator 10A of a modified example;

FIG. 7 is a schematic perspective view of a radiation detector 2 using a scintillator 110, which is a modified example;

FIG. 8 is a view of the scintillator 110 as seen from the direction of arrow AR1 in FIG. 7;

FIG. 9A is a diagram illustrating magnitude of output of light receiving element when scintillation light is generated in segment (C);

FIG. 9B is a diagram illustrating magnitudes of outputs of light receiving elements when scintillation light is generated in segment (G);

FIG. 10 is a histogram summarizing calculation results of DOI information using the light receiving element 120C having the identification number i=0 as a reference;

FIG. 11 is an example of a flood map. In FIG. 11, reference signs Energy0 to Energy3 represent outputs of the light receiving elements 120A to 120D;

FIG. 12 is an example of a flowchart of a method for identifying a position in the Z direction; and

FIG. 13 is a diagram illustrating a frequency distribution (flood map) of gamma-ray events in the two-dimensional direction.

### DETAILED DESCRIPTION

### Embodiment 1

Hereinafter, a radiation detector 1 according to Embodiment 1 of the present disclosure will be described with reference to the accompanying drawings. In the drawings, corresponding components are denoted by the same reference numerals, and redundant descriptions thereof are omitted.

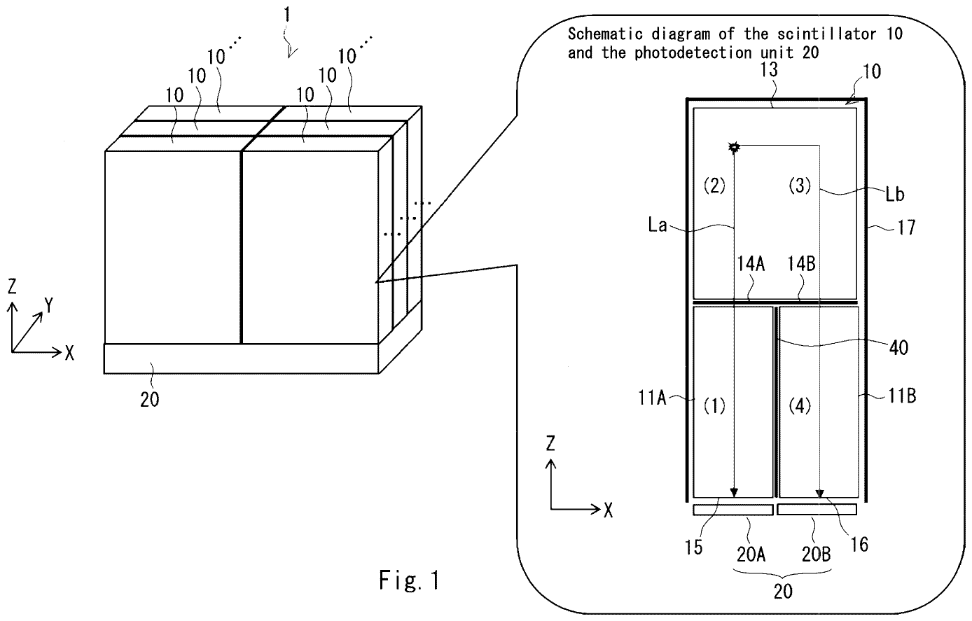

FIG. 1 is a schematic configuration diagram of the radiation detector 1 according to Embodiment 1.

As illustrated in FIG. 1, the radiation detector 1 includes a plurality of scintillators 10 and a light detection unit 20. The plurality of scintillators 10 are arranged in a matrix in an XY direction. Each scintillator 10 is covered with a reflective member 17 in order to prevent scintillation light from traveling between adjacent scintillators 10.

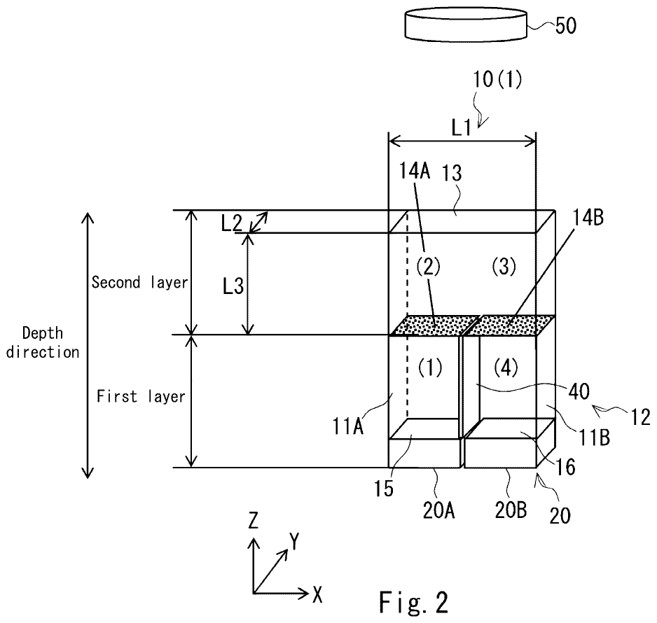

FIG. 2 is a perspective view of a scintillator 10 and a light detection unit 20 (partially) extracted from FIG. 1. For convenience of explanation, a reflective member 17 is omitted in FIG. 2. For convenience of explanation, as illustrated in FIG. 2 and the like, an X-axis, a Y-axis, and a Z-axis are defined. The X-axis extends in a left-right direction in FIG. 2. The Z-axis extends in an up-down direction in FIG. 2. The Y-axis extends in a direction orthogonal to an XZ plane.

As illustrated in FIG. 2, the scintillator 10 includes a scintillator array 12 including first scintillator blocks 11A and 11B arranged in parallel with each other in a first layer, and one second scintillator block 13 arranged in a second layer so as to extend across the first scintillator blocks 11A and 11B. The material of the scintillator 10 is, for example, a crystal (crystal lump) such as Bi₄Ge₃O₁₂ (BGO), Ce-doped Lu₂SiO₅ (LSO), Lu₂(1-x) Y₂xSiO₅ (LYSO), Gd₂SiO₅ (GSO), Pr-doped LuAG (Lu₃Al₅O₁₂), Ce-doped LaBr₃ (LaBr₃), Ce-doped LaCl₃ (LaCl₃), or Ce-doped Lu_{0.7}Y_{0.3}AlO₃ (LuYAP), Lutetium Fine Silicate (LFS), and the like.

A reflective member 40 is disposed between adjacent first scintillator blocks 11A and 11B mainly in order to prevent scintillation light from traveling between the adjacent first scintillator blocks 11A and 11B. The reflective member 40 is, for example, an ESR (Enhanced Specular Reflector Film) reflective material.

First, the first scintillator blocks 11A and 11B will be described. Since the first scintillator blocks 11A and 11B have the same configuration, hereinafter, the first scintillator block 11A will be described as a representative.

The first scintillator block 11A is a rectangular column shape scintillator block including a pair of surfaces parallel to an XY plane, a pair of surfaces parallel to an XZ plane, and a pair of surfaces parallel to a YZ plane. Note that the first scintillator block 11A may have a polygonal column shape other than the quadrangular prism shape. All surfaces of the first scintillator block 11A are flatly polished. This polishing may be mechanical polishing or chemical polishing. Note that the surfaces of the first scintillator block 11A are not limited to mirror surfaces. That is, as long as scintillation light in an amount required for the light receiving elements 20A and 20B is incident, each surface of the first scintillator block 11A may be a diffuse reflection surface, an absorption surface, a translucent surface, or an arbitrary surface combining these.

The first scintillator blocks 11A and 11B are adjacently arranged in an X direction with their respective side surfaces (surfaces parallel to a YZ plane) facing each other. At this time, the first scintillator block 11A and the first scintillator block 11B are arranged such that, when projected onto the YZ plane, their respective outer shapes coincide on the YZ plane.

Next, the second scintillator block 13 will be described.

The second scintillator block 13 is a rectangular column shape scintillator block including a pair of surfaces parallel to an XY plane, a pair of surfaces parallel to an XZ plane, and a pair of surfaces parallel to a YZ plane. Note that the second scintillator block 13 may have a polygonal column shape other than the quadrangular prism shape. An X-direction length L1 of the second scintillator block 13 is twice an X-direction length of the first scintillator block 11A plus an X-direction thickness of the reflective member 40. On the other hand, a Y-direction length L2 and a Z-direction length L3 of the second scintillator block 13 are the same as a Y-direction length and a Z-direction length of the first scintillator block 11A. Note that the Z-direction length (a height of the scintillator) of the second scintillator block 13 may be different from that of the first scintillator block 11A. All surfaces of the second scintillator block 13 are flatly polished. This polishing may be mechanical polishing or chemical polishing. Note that the surfaces of the second scintillator block 13 are not limited to mirror surfaces. That is, as long as scintillation light in an amount required for the light receiving elements 20A and 20B is incident, each surface of the second scintillator block 13 may be a diffuse reflection surface, an absorption surface, a translucent surface, or an arbitrary surface combining these.

The scintillator array 12 (the first scintillator blocks 11A and 11B) and the second scintillator block 13 are adjacently arranged in a Z direction with surfaces of the first scintillator blocks 11A and 11B parallel to an XY plane (upper surfaces in FIG. 2) and a surface of the second scintillator block 13 parallel to the XY plane (a lower surface in FIG. 2) facing each other. At this time, the scintillator array 12 and the second scintillator block 13 are arranged such that, when projected onto the XY plane, their respective outer shapes coincide on the XY plane.

The first scintillator block 11A and the second scintillator block 13 are bonded by an optical adhesive layer 14A provided between a surface of the first scintillator block 11A parallel to an XY plane (an upper surface in FIG. 2) and a surface of the second scintillator block 13 parallel to the XY plane (a lower surface in FIG. 2). Similarly, the first scintillator block 11B and the second scintillator block 13 are bonded by an optical adhesive layer 14B provided between a surface of the first scintillator block 11B parallel to the XY plane (an upper surface in FIG. 2) and a surface of the second scintillator block 13 parallel to the XY plane (a lower surface in FIG. 2). The optical adhesive layers 14A and 14B are an example of a first optical discontinuity portion of the present disclosure.

Hereinafter, the first scintillator blocks 11A and 11B may be referred to as segments (1) and (4), respectively. Further, a portion of the second scintillator block 13 located directly above the first scintillator block 11A and a portion of the second scintillator block 13 located directly above the first scintillator block 11B may be referred to as segments (2) and (3), respectively.

In the scintillator 10 having the above configuration, that is, among scintillation light generated in any of segments (1) to (4), a part of scintillation light La (see FIG. 1) propagates to one end surface 15 of the first scintillator block 11A parallel to an XY plane (a lower surface in FIG. 2), and is incident on a light receiving element 20A optically coupled to the one end surface 15. Similarly, among scintillation light generated in segments (1) to (4), another part of scintillation light Lb propagates to the other end surface 16 of the first scintillator block 11B parallel to the XY plane (a lower surface in FIG. 2), and is incident on a light receiving element 20B optically coupled to the other end surface 16. The light receiving elements 20A and 20B each output an electrical signal corresponding to light (photons) incident thereon.

Next, a method for identifying a segment in which scintillation light is generated will be described.

First, as illustrated in FIG. 2, a radiation source 50 that emits radiation in a 360-degree direction while facing the scintillator 10 (for example, a disk radiation source using radioactive isotope sodium-22) is disposed, and each time scintillation light is generated during a predetermined period (about 3 minutes), DOI information is calculated using the following Equation (1) and stored in a storage device (not illustrated).

$$\begin{matrix}[ Math . 1 ] & \\ DOI = \frac{B}{A + B} & Equation ( 1 )\end{matrix}$$

However, DOI represents DOI information, A represents an output value of the light receiving element 20A, and B represents an output value of the light receiving element 20B.

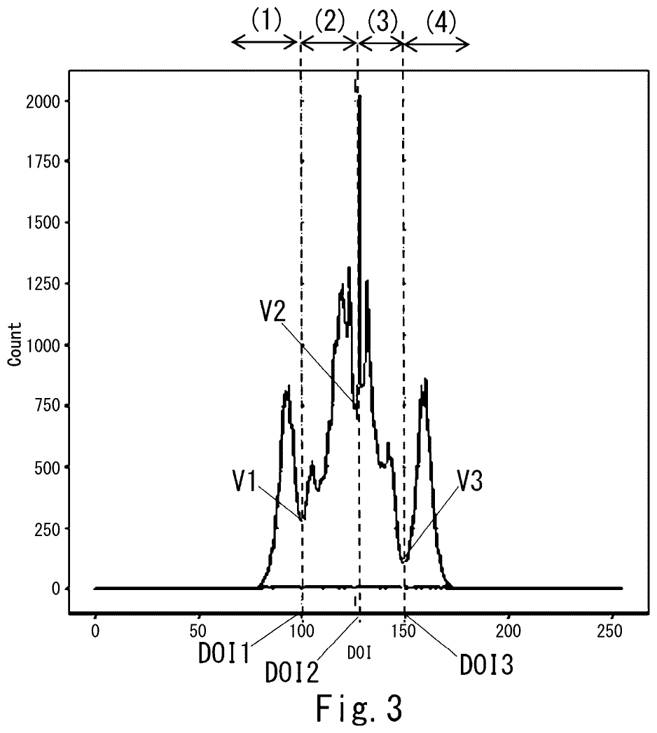

FIG. 3 is a histogram summarizing calculation results of the DOI information. In FIG. 3, a vertical axis represents the number of event occurrences, and a horizontal axis represents the DOI information.

Referring to FIG. 3, it can be seen that valleys V1, V2, and V3 exist between segment (1) and segment (2), between segment (2) and segment (3), and between segment (3) and segment (4), respectively. In FIG. 3, reference signs DOI1, DOI2, and DOI3 represent DOI information corresponding to valleys V1, V2, and V3, respectively.

The DOI information can be calculated using the above Equation (1) each time scintillation light is generated and outputs of the light receiving elements 20A and 20B are obtained. By comparing the calculated DOI information with DOI information DOI1 to DOI3 (threshold values), a light emission position in the Z direction is determined, that is, a segment in which scintillation light is generated can be identified.

For example, when the calculated DOI information is less than DOI1, a segment in which scintillation light is generated can be identified as segment (1). Similarly, when DOI1 is less than the calculated DOI information and the calculated DOI information is less than DOI2, the segment in which scintillation light is generated can be identified as segment (2). Similarly, when DOI2 is less than the calculated DOI information and the calculated DOI information is less than DOI3, the segment in which scintillation light is generated can be identified as segment (3). Similarly, when DOI3 is less than the calculated DOI information, the segment in which scintillation light is generated can be identified as segment (4).

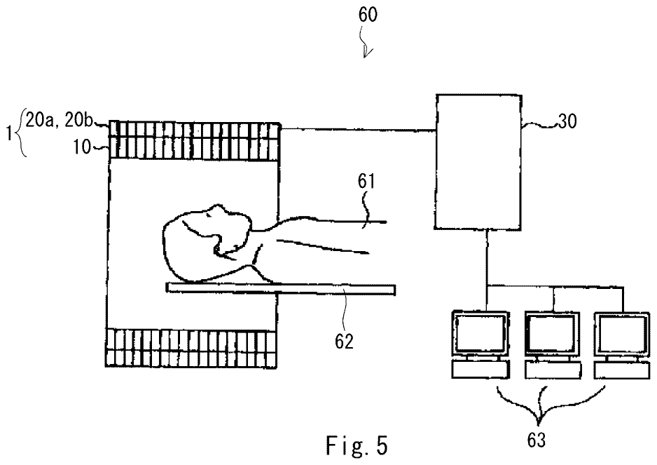

The light detection unit 20 includes a first light receiving element 20A optically coupled to the end surface 15 of one of the first scintillator blocks 11A, and a second light receiving element 20B optically coupled to the end surface 16 of the other first scintillator block 11B. The light receiving elements 20A and 20B are, for example, semiconductor photodetectors using MPPCs (Multi-Pixel Photon Counters). An MPPC is a photon-counting device composed of a plurality of Geiger-mode APD pixels. The light receiving elements 20A and 20B output electrical signals corresponding to light (photons) incident thereon. These electrical signals are input to a signal processing circuit 30 (see FIG. 5).

Next, a positron emission tomography apparatus 60 (PET (Positron Emission Tomography) apparatus) to which the radiation detector 1 of the present disclosure is applied will be briefly described.

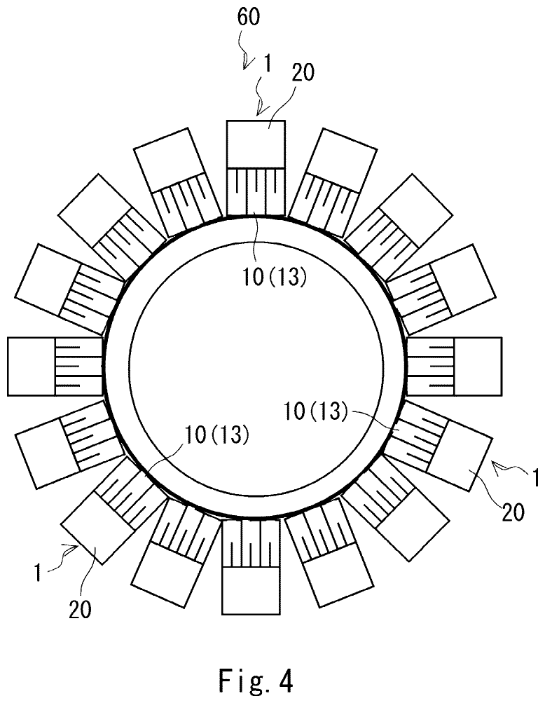

FIGS. 4 and 5 illustrate an example of a positron emission tomography apparatus 60 to which the radiation detector 1 of the present disclosure is applied.

As shown in FIGS. 4 and 5, the positron emission tomography apparatus 60 includes a subject holding unit 62 that holds a subject 61 to which a radiopharmaceutical has been administered, a plurality of radiation detectors 1 arranged in a ring shape to detect radiation (annihilation gamma rays) generated from the subject 61, and means that, based on outputs of the radiation detectors 1 (the light detection units 20), identify segments (positions) in which scintillation light is generated, sequentially record the identified positions in a memory (not illustrated), identify positions of radiation emission sites from the recorded positions using a mathematical method, and display the identified positions on a display device 63 (for example, the signal processing circuit 30). At this time, the signal processing circuit 30 executes processing for identifying a position (segment) in which scintillation light is generated by comparing the DOI information calculated as described above with DOI information DOI1 to DOI3 (threshold values) stored in a storage device (not illustrated). Note that the subject holding unit 62 may be a bed on which the subject 61 lies, or may be a chair on which the subject 61 sits.

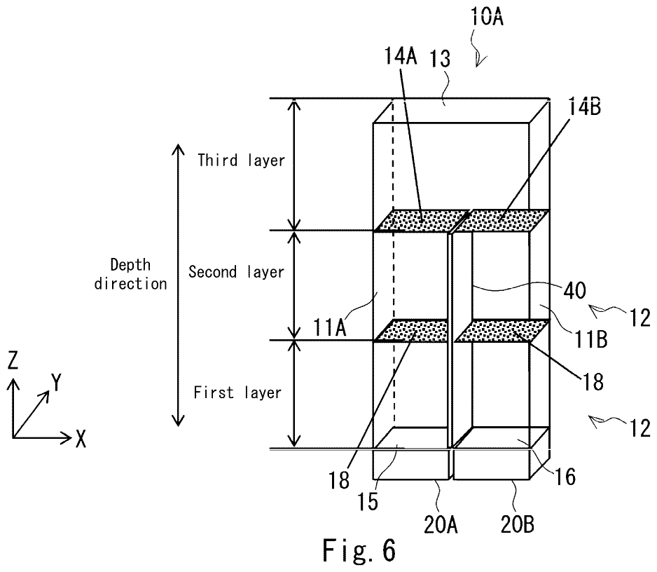

As described above, according to the present embodiment, since the scintillator 10 configured by the first scintillator blocks 11A and 11B and the second scintillator block 13, which are separate from each other, and the optical adhesive layers 14A and 14B (the first optical discontinuity portion) provided between them is used, a modification region formed by laser irradiation can be omitted (partially omitted or entirely omitted). FIG. 2 illustrates an example in which the modification region is entirely omitted, and FIG. 6 illustrates an example in which the modification region is partially omitted. As a result, compared with Patent Document 1 in which a modification region formed by laser irradiation is provided in each scintillator, it becomes possible to reduce manufacturing cost of the scintillator 10 and manufacturing time of the scintillator 10.

Further, according to the present embodiment, since one second scintillator block 13 only needs to be prepared for a plurality of first scintillator blocks 11A and 11B in a first layer, the number of scintillator blocks can be reduced. Further, according to the present embodiment, the number of polished surfaces of the scintillator blocks can also be reduced. As a result, it becomes possible to reduce costs by simplifying assembly of the scintillator blocks 11A, 11B, and 13.

Further, according to the present embodiment, there is also an advantage that calibration in a DOI direction (for determining a gamma-ray interaction position), which has conventionally been performed in a scintillator in which a modification region formed by laser irradiation is not formed, is unnecessary.

Further, according to the present embodiment, each of the plurality of first scintillator blocks 11A and 11B may be partitioned into a plurality of segments by at least one modified layer 18 (a second optical discontinuity portion) (see FIG. 6). In this case, it becomes possible to detect generation of scintillation light in a plurality of layers of three or more layers.

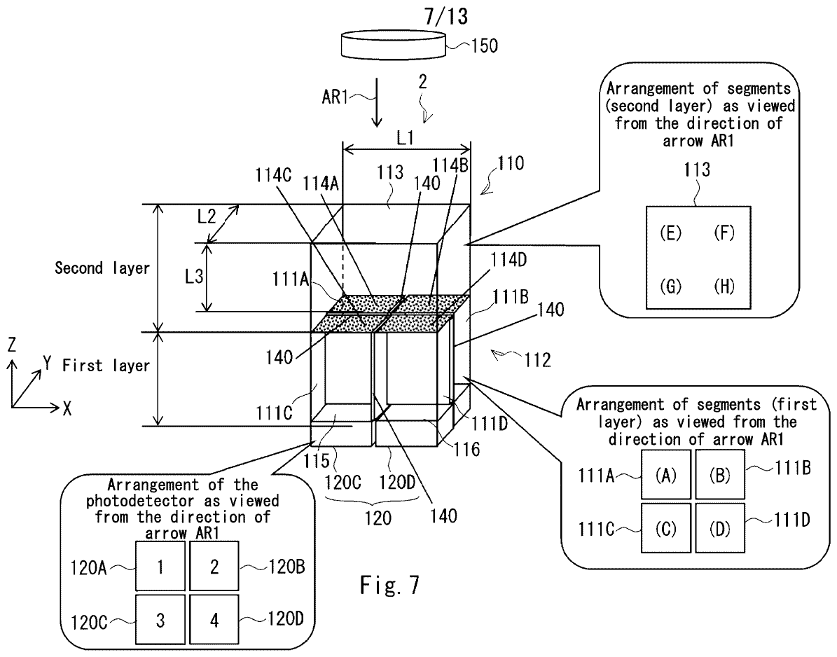

Further, according to the present embodiment, a plurality of first scintillator blocks 111A, 111B, 111C, and 111D may be arranged in a matrix in a first layer (see FIG. 7). In this case, since one second scintillator block 113 only needs to be prepared for the plurality of first scintillator blocks 111A, 111B, 111C, and 111D in the first layer, the number of scintillator blocks can be reduced.

Further, the number of polished surfaces of the scintillator blocks can also be reduced. As a result, it becomes possible to reduce costs by simplifying assembly of the scintillators.

Next, a modified example will be described.

In the above embodiment, an example in which the scintillator 10 having scintillator blocks arranged in two layers is used has been described; however, the present disclosure is not limited thereto. FIG. 6 is a perspective view of a scintillator 10A of a modified example. For example, as illustrated in FIG. 6, by forming modified layers 18 by laser processing in each of the first scintillator blocks 11A and 11B, a scintillator 10A in which scintillator blocks are arranged in three or more layers may be configured. Further, although not illustrated, by bonding another first scintillator block 11A, 11B to each of the first scintillator blocks 11A and 11B via an optical adhesive layer, a scintillator in which scintillator blocks are arranged in three or more layers may be configured. Further, in the above embodiment, an air layer may be used in place of the modified layer 18. The modified layer 18, the air layer, and the optical adhesive layer are examples of a second optical discontinuity portion of the present disclosure.

Next, a scintillator 110, which is a modified example, will be described.

FIG. 7 is a schematic perspective view of a radiation detector 2 using a scintillator 110, which is a modified example.

As illustrated in FIG. 7, the radiation detector 2 includes a scintillator 110 and a light detection unit 120.

The scintillator 10 of the above embodiment includes two first scintillator blocks 11A and 11B arranged in parallel with each other in a first layer (see FIG. 2), whereas the scintillator 110 of the present modified example differs in that it includes four first scintillator blocks 111A, 111B, 111C, and 111D arranged in parallel with each other in the first layer (see FIG. 7). Further, the scintillator 10 of the above embodiment includes one second scintillator block 13 arranged in a second layer so as to extend across the two first scintillator blocks 11A and 11B (see FIG. 2), whereas the scintillator 110 of the present modified example differs in that it includes one second scintillator block 113 arranged in the second layer so as to extend across the four first scintillator blocks 111A, 111B, 111C, and 111D (see FIG. 7).

The material of the scintillator 110 is the same as that of the scintillator 10, and therefore a description thereof is omitted.

A reflective member 140 is disposed between adjacent first scintillator blocks 111A, 111B, 111C, and 111D in order to prevent scintillation light from traveling between the adjacent first scintillator blocks 111A, 111B, 111C, and 111D. The reflective member 140 is, for example, an ESR (Enhanced Specular Reflector Film) reflective material.

First, the first scintillator blocks 111A, 111B, 111C, and 111D will be described. Since the first scintillator blocks 111A, 111B, 111C, and 111D have the same configuration, the first scintillator block 111A will be representatively described below.

The first scintillator block 111A, similarly to the first scintillator block 11A, is a scintillator block having a rectangular column shape including a pair of surfaces parallel to the XY plane, a pair of surfaces parallel to the XZ plane, and a pair of surfaces parallel to the YZ plane. The first scintillator block 111A may have a polygonal column shape other than a rectangular column shape. All surfaces of the first scintillator block 111A are polished to be flat. This polishing may be mechanical polishing or chemical polishing. The respective surfaces of the first scintillator block 111A are not limited to mirror surfaces. That is, as long as a required amount of scintillation light for the light receiving elements 120A to 120D is incident, the respective surfaces of the first scintillator block 111A may be diffuse reflection surfaces, absorption surfaces, translucent surfaces, or arbitrary surfaces combining these.

The first scintillator blocks 111A, 111B, 111C, and 111D are adjacently arranged in a matrix (2×2) in the X direction and the Y direction with their respective side surfaces facing each other. At that time, the first scintillator blocks 111A and 111B are arranged such that, when projected onto the YZ plane, their respective outer shapes coincide on the YZ plane. The same applies to the first scintillator blocks 111C and 111D.

Next, the second scintillator block 113 will be described.

The second scintillator block 113, similarly to the second scintillator block 13, is a scintillator block having a rectangular column shape including a pair of surfaces parallel to the XY plane, a pair of surfaces parallel to the XZ plane, and a pair of surfaces parallel to the YZ plane. The second scintillator block 113 may have a polygonal column shape other than a rectangular column shape. The length L1 in the X direction and the length L2 in the Y direction of the second scintillator block 113 are each twice the length in the X direction and the length in the Y direction of the first scintillator block 11A, and the length L3 in the Z direction of the second scintillator block 113 is the same as the length in the Z direction of the first scintillator block 11A. The length in the Z direction (height of the scintillator) of the second scintillator block 113 may be different from that of the first scintillator block 11A. All surfaces of the second scintillator block 113 are polished to be flat. This polishing may be mechanical polishing or chemical polishing. The respective surfaces of the second scintillator block 113 are not limited to mirror surfaces. That is, as long as a required amount of scintillation light for the light receiving elements 120A to 120D is incident, the respective surfaces of the second scintillator block 113 may be diffuse reflection surfaces, absorption surfaces, translucent surfaces, or arbitrary surfaces combining these.

The scintillator array 112 (the first scintillator blocks 111A, 111B, 111C, and 111D) and the second scintillator block 113 are adjacently arranged in the Z direction with surfaces of the first scintillator blocks 111A, 111B, 111C, and 111D that are parallel to the XY plane (upper surfaces in FIG. 7) facing surfaces of the second scintillator block 113 that are parallel to the XY plane (lower surface in FIG. 7). At that time, the scintillator array 112 and the second scintillator block 113 are arranged such that, when projected onto the XY plane, their respective outer shapes coincide on the XY plane.

The first scintillator block 111A and the second scintillator block 113 are bonded to each other by an optical adhesive layer 114A provided between a surface of the first scintillator block 111A parallel to the XY plane (upper surface in FIG. 7) and a surface of the second scintillator block 113 parallel to the XY plane (lower surface in FIG. 7). Similarly, the first scintillator block 111B and the second scintillator block 113 are bonded to each other by an optical adhesive layer 114B provided between a surface of the first scintillator block 111B parallel to the XY plane (upper surface in FIG. 7) and a surface of the second scintillator block 113 parallel to the XY plane (lower surface in FIG. 7). Similarly, the first scintillator block 111C and the second scintillator block 113 are bonded to each other by an optical adhesive layer 114C provided between a surface of the first scintillator block 111C parallel to the XY plane (upper surface in FIG. 7) and a surface of the second scintillator block 113 parallel to the XY plane (lower surface in FIG. 7). Similarly, the first scintillator block 111D and the second scintillator block 113 are bonded to each other by an optical adhesive layer 114D provided between a surface of the first scintillator block 111D parallel to the XY plane (upper surface in FIG. 7) and a surface of the second scintillator block 113 parallel to the XY plane (lower surface in FIG. 7). An air layer may be used instead of the optical adhesive layers 114A, 114B, 114C, and 114D. The optical adhesive layers 114A, 114B, 114C, and 114D and the air layer are examples of a first optical discontinuity portion of the present disclosure.

Hereinafter, the first scintillator blocks 111A, 111B, 111C, and 111D may be respectively referred to as segments (A), (B), (C), and (D). Further, portions of the second scintillator block 113 located directly above the first scintillator blocks 111A, 111B, 111C, and 111D may be respectively referred to as segments (E), (F), (G), and (H).

Scintillation light generated in the scintillator 110 having the above configuration, that is, in any one of the segments (A) to (H), propagates to end surfaces of the first scintillator blocks 111A, 111B, 111C, and 111D that are parallel to the XY plane (lower surfaces in FIG. 7), and enters light receiving elements 120A to 120D optically connected to the respective end surfaces. The light receiving elements 120A to 120D output electrical signals corresponding to the light (photons) incident thereon.

Next, a method for identifying a segment in which scintillation light has been generated will be described. The segment in which scintillation light has been generated is identified based on a position in the XY direction and a position in the Z direction.

First, a method for identifying a position in the XY direction will be described.

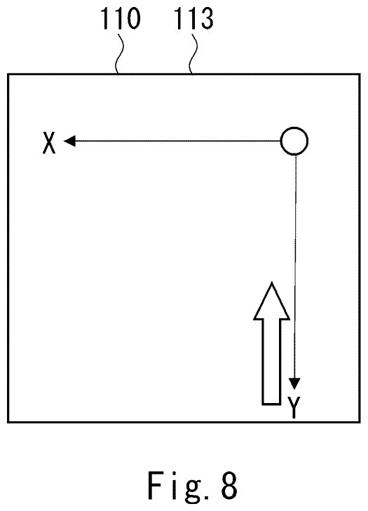

FIG. 8 is a view of the scintillator 110 as seen from the direction of arrow AR1 in FIG. 7.

First, calibration data for discriminating a gamma-ray emission position in a two-dimensional direction is acquired. The calibration data refers to reference data in which a known gamma-ray emission position is associated with outputs of the light receiving elements 120A to 120D in order to accurately identify the gamma-ray emission position in two dimensions (XY direction). The calibration data can be obtained, for example, by a known method using a collimated radiation source (for example, a radiation source using radioactive isotope sodium-22) and a reference radiation detector.

Next, a flood map is created from outputs of the light receiving elements 120A to 120D, and thresholds for discriminating positions in a two-dimensional direction are set. The flood map is data obtained by calculating output ratios of the light receiving elements 120A to 120D detected for each event and representing the calculated output ratios as a frequency distribution in a two-dimensional direction (XY direction). This flood map can be calculated by a known method based on the outputs of the light receiving elements 120A to 120D. By comparing this flood map with the outputs of the light receiving elements 120A to 120D, it is possible to discriminate, in the two-dimensional direction, a segment in which a target event has occurred (for example, “segment (A) or (E)” or “segment (D) or (H)”).

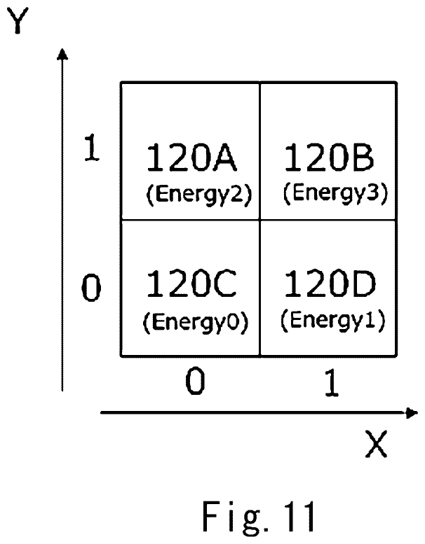

FIG. 11 is an example of a flood map. In FIG. 11, reference signs Energy0 to Energy3 represent outputs of the light receiving elements 120A to 120D.

The flood map can be created as follows.

First, sums of outputs in the Y direction and the X direction (sum_Vx, sum_h) are calculated from the four light receiving elements 120A to 120D using the following Equations (2) and (3).

$$\begin{matrix}[ Math . 2 ] & \\ {sum\_v}_{x} = {\sum }_{y = 0}^{1} Energy ( 2 y + x ) & Equation ( 2 )\end{matrix}$$

$${sum\_h}_{y} = {\sum }_{x = 0}^{1} Energy ( 2 y + x ) \qquad Equation ( 3 )$$

Next, by weighting sum_Vx and sum_hy using the following Equations (4) and (5), a two-dimensional emission position of an event (sum_Vxg, sum_hyg) is calculated.

$$\begin{matrix}[ Math . 3 ] & \\ {sum\_v}_{xg} = {\sum }_{x = 0}^{1} \frac{x + 1}{3} {sum\_v}_{x} & Equation ( 4 )\end{matrix}$$

$${sum\_h}_{yg} = {\sum }_{y = 0}^{1} \frac{y + 1}{3} {sum\_h}_{y} \qquad Equation ( 5 )$$

Next, for each event, calculations using the above Equations (2) to (5) are performed, and by forming a frequency distribution in the two-dimensional direction, a flood map can be created.

Next, a method for identifying a position in the Z direction will be described.

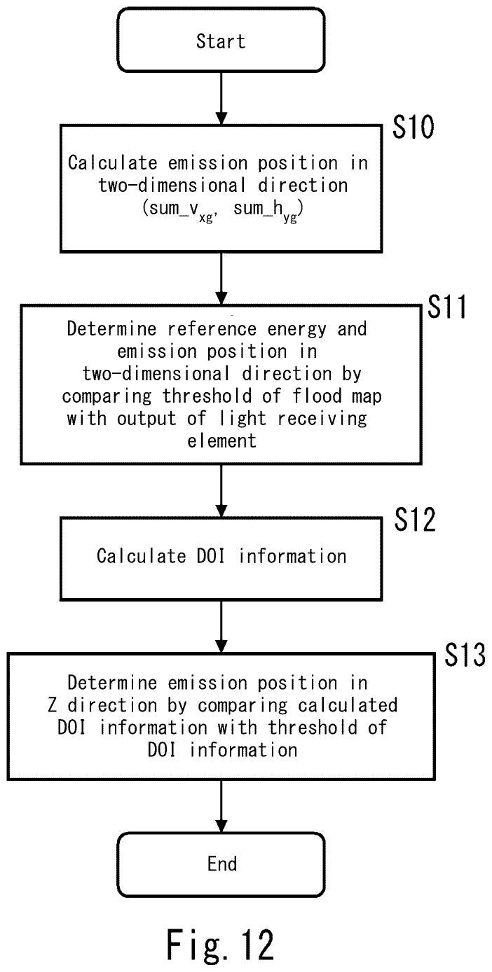

FIG. 12 is an example of a flowchart of a method for identifying a position in the Z direction.

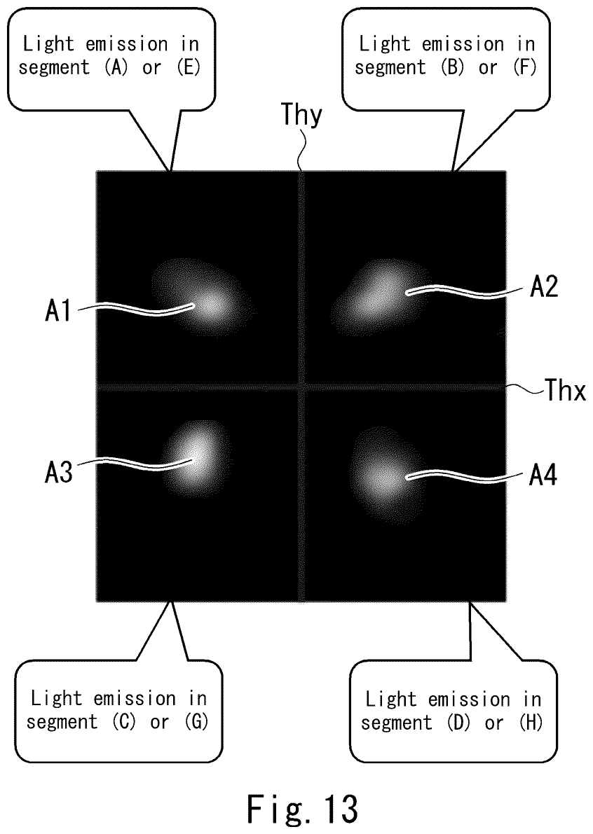

Hereinafter, description will be given on the assumption that a flood map and thresholds thereof have been created in advance and stored in a storage unit (not shown). The following steps S10 to S13 are executed for each event. First, the emission position in the two-dimensional direction (sum_vxg, sum_hyg) is calculated using the above equations (2) to (5) (step S10). Next, by comparing the thresholds of the flood map (Thx and Thy shown in FIG. 13) with the outputs of the light receiving elements 120A to 120D, a reference Energy (here, Energy) and the emission position in the two-dimensional direction (here, “segment (D) or (H)”) are determined.

FIG. 13 is a diagram illustrating a frequency distribution (flood map) of gamma-ray events in the two-dimensional direction. In FIG. 13, reference signs A1 to A4 each represent a region (white regions in FIG. 13) in which gamma-ray events are concentrated. The thresholds Thx and Thy in FIG. 13 may be manually set by visually observing the flood map (for example, see FIG. 13), may be automatically set at intermediate positions between adjacent regions A1 to A4 in the two-dimensional direction, or may be set by another method.

Next, DOI information is calculated using the following equation (6) (step S12).

$$\begin{matrix}[ Math . 4 ] & \\ DOI = \frac{{Energy}_{3}}{{\sum }_{i = 0}^{3} {Energy}_{i}} & Equation ( 6 )\end{matrix}$$

Here, DOI represents DOI information, n represents an identification number of a light receiving element, and Energyₙ represents an output value of the light receiving element having the identification number n. In this case, the numerator on the right-hand side of equation (6) is Energy3, and equation (6) indicates DOI information using the light receiving element having the identification number i=0 as a reference. Here, the identification number of the light receiving element 120A is i=2, the identification number of the light receiving element 120B is i=3, the identification number of the light receiving element 120C is i=0, and the identification number of the light receiving element 120D is i=1.

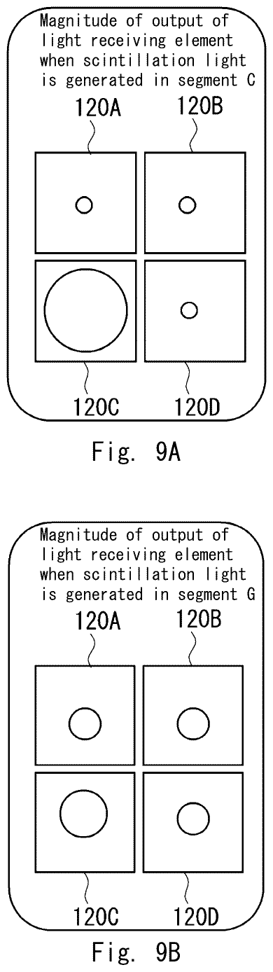

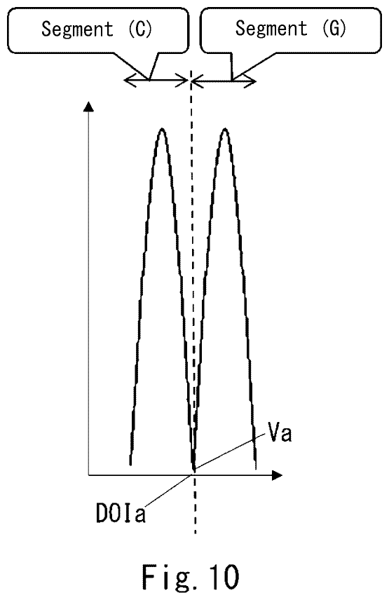

FIG. 9A is a diagram illustrating magnitude of output of light receiving element when scintillation light is generated in segment (C), and FIG. 9B) is a diagram illustrating magnitude of output of light receiving element when scintillation light is generated in segment (G). Each circle in FIG. 9A represents a magnitude of an output of each of the light receiving elements 120A to 120D when scintillation light is generated in segment (C). Similarly, each circle in FIG. 9B represents a magnitude of an output of each of the light receiving elements 120A to 120D when scintillation light is generated in segment (G). As described above, ratios of outputs of the light receiving elements differ depending on a segment (a position in the Z direction) in which scintillation light is generated. As a result, a histogram summarizing calculation results of DOI information using the light receiving element 120C having an identification number i=0 as a reference is, for example, as shown in FIG. 10. FIG. 10 is a histogram summarizing calculation results of DOI information using the light receiving element 120C having the identification number i=0 as a reference. In FIG. 10, the vertical axis represents the number of event occurrences, and the horizontal axis represents DOI information.

Referring to FIG. 10, it can be seen that a valley Va exists between segment (C) and segment (G). In FIG. 10, reference sign DOIa represents DOI information corresponding to the valley Va, using the light receiving element 120C having the identification number i=0 as a reference.

DOI information can be calculated using the above equation (6) each time scintillation light is generated in segment (C) or segment (G) and outputs are obtained from the light receiving elements 120A to 120D. Then, by comparing the calculated DOI information with a threshold of the DOI information (DOI information DOIa), an emission position in the Z direction is determined (step S13), that is, a segment in which the scintillation light is generated can be identified.

For example, when the calculated DOI information is less than DOIa, a segment in which scintillation light is generated can be identified as segment (C). Similarly, when the calculated DOI information is greater than DOIa, a segment in which scintillation light is generated can be identified as segment (G).

In the same manner as described above, when scintillation light is generated in segment (A) or segment (E), in segment (B) or segment (F), or in segment (D) or segment (H), the segment in which the scintillation light is generated can also be identified.

According to this modified example as well, effects similar to those of the above embodiment can be achieved. In this modified example, an example using a combination of 2×2 first scintillator blocks and light receiving elements has been described; however, the present disclosure is not limited thereto. That is, as long as the first scintillator blocks and the light receiving elements have a one-to-one correspondence, combinations of first scintillator blocks and light receiving elements such as 3×3, 4×4, 6×12, and the like may also be used.

All numerical values presented in the above embodiments are illustrative only, and it goes without saying that other appropriate numerical values different therefrom may be employed.

The above embodiments are merely examples in all respects. The present disclosure should not be construed as being limited by the description of the above embodiments. The present disclosure may be embodied in various other forms without departing from the spirit or essential characteristics thereof.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A radiation detector comprising:
a scintillator array including a plurality of first scintillator blocks arranged in parallel with each other in a first layer;
one second scintillator block arranged in a second layer so as to extend across each of the plurality of first scintillator blocks;
a reflective member disposed between adjacent ones of the first scintillator blocks;
a first optical discontinuity portion provided between each of the plurality of first scintillator blocks and the second scintillator block; and
a light detection unit optically coupled to an end surface of one of the first scintillator blocks and an end surface of another of the first scintillator blocks.

2. The radiation detector according to claim 1, wherein each of the plurality of first scintillator blocks is partitioned into a plurality of segments by at least one second optical discontinuity.

3. The radiation detector according to claim 1, wherein the plurality of first scintillator blocks is arranged in a matrix in the first layer.

4. The radiation detector according to claim 1, wherein the first optical discontinuity portion is an optical adhesive layer or an air layer.

5. The radiation detector according to claim 2, wherein the second optical discontinuity is a modified layer formed by laser irradiation on the first scintillator block, an air layer, or an optical adhesive layer.

6. The radiation detector according to claim 1, wherein the light detection unit includes at least one first light receiving element optically coupled to an end surface of one of the first scintillator blocks, and at least one second light receiving element optically coupled to an end surface of the other of the first scintillator blocks.

7. A positron emission tomography apparatus comprising:
a subject holding unit configured to hold a subject to which a radioactive agent has been administered;
radiation detectors arranged in a ring shape for detecting radiation emitted from the subject; and
means for, based on outputs of the radiation detectors, identifying a position at which scintillation light is generated, recording the identified position, identifying a position of a radiation emission site from the recorded positions using a mathematical method, and displaying the identified position on a display device,
wherein the radiation detector comprises:
a scintillator array including a plurality of first scintillator blocks arranged in parallel with each other in a first layer;
one second scintillator block arranged in a second layer so as to extend across each of the plurality of first scintillator blocks;
a reflective member disposed between adjacent ones of the first scintillator blocks;
a first optical discontinuity portion provided between each of the plurality of first scintillator blocks and the second scintillator block; and
a light detection unit optically coupled to an end surface of one of the first scintillator blocks and to an end surface of the other of the first scintillator blocks.
